(19) United States
(12) Patent Application Publication
(10) Pub. No.: US 2009/0035431 A1
(43) Pub. Date: Feb. 5, 2009

(54) Filter Layer

(75) Inventor: Jurgen Ebert, Wil (CH)

Correspondence Address: SHOEMAKER AND MATTARE, LTD, 10 POST OFFICE ROAD - SUITE 110, SILVER SPRING, MD, 20910, US

(73) Assignee: FILTROX AG, St. Gallen (CH)

(21) Appl. No.: 12/026,063

(22) Filed: Feb. 5, 2008

(30) Foreign Application Priority Data
Feb. 26, 2007 (EP) 07103040.7

(51) Int. Cl. C12H 1/02; B01D 39/20; B01J 20/18; B01J 20/20; B01J 20/26; B01J 20/285; B01J 20/24

(52) U.S. Cl. 426/423; 210/502.1; 502/404; 502/60; 502/79; 502/416; 502/402

(57) ABSTRACT

The invention relates to a filter layer containing an adsorbent for the directed removal of a substance which adversely affects the taste from a fluid composition, in particular from wine. As adsorbent, particular preference is given to using a zeolite which has the periodic structural unit (PSU) of faujasites, in particular with a ratio of Si/Al of ≧5, preferably ≧10. The filter layer of the invention is able to remove 2,4,6-trichloroanisole (mainly responsible for the cork taste) from wine; other advantageous flavours are, in contrast, largely not removed.

The invention relates to a filter layer comprising an adsorbent for the directed removal of a substance which adversely affects the taste from a fluid composition, in particular from wine, and also a process for producing such a filter layer, according to the independent claims.

In wine production, the cork taste, in particular, is a great problem. The losses incurred annually in the wine industry as a result of cork taste is estimated at about US $200 million. The compound mainly responsible for the cork taste in wine has been identified as 2,4,6-trichloroanisole (TCA) which is presumably produced by microorganisms from chlorinated compounds. Human perception of TCA in wine extends down to about 5 ng/l, but even at still smaller amounts of, for example, about 2 ng/l a masking effect on desirable fruit flavours is still found.

A variety of approaches aimed at preventing TCA contamination of wine or removing existing TCA from wine have been proposed. Up to now, none of the known methods has achieved any great importance, especially for cost reasons and because of the only unsatisfactory specificity for TCA, so that other flavours are also removed and the character of the wine is altered in an intolerable way.

The treatment of wine with milk or cream/milk mixtures in order to remove TCA is also known (in the USA permissible for the treatment of wine in accordance with 27 CFR 24.246), but data on the flavour profile achieved as a result of such treatment are not. In addition, the introduction of allergenic substances by the milk is a potential problem for people suffering from allergies.

It is therefore an object of the invention to avoid the disadvantages of the known processes, in particular to provide a filter layer and a process which makes rapid, very selective and inexpensive removal of substances which adversely affect the taste, in particular TCA, from fluid compositions, in particular from wine, possible.

The object is achieved by a filter layer comprising an adsorbent for the directed removal of a substance which adversely affects the taste from a fluid composition, in particular from wine, and also a process for producing such a filter layer, according to the independent claims.

The filter layer of the invention contains an adsorbent for the directed removal of a substance which adversely affects the taste from a fluid composition, in particular from wine.

Here and in the following, a filter layer is an in particular sheet-like structure through which a fluid medium can be passed to remove undesirable constituents such as solids and/or, in particular, taste-imparting and/or odorous substances which are present in solution. For the purposes of the invention, preference is given to, in particular, prefabricated filter sheets, for example filter sheets produced from prepared celluloses, if appropriate with incorporated fillers (for example kieselguhrs or perlites) and customary agents to improve the wet strength (for example PAAE resins); however, the filter layer can also be, for example, a filter layer produced in situ by filtration of a slurry of the loose material.

In preferred embodiments, the filter layer comprises a matrix which ensures a defined three-dimensional cohesion of the filter layer in the dry state. This can be a fibre matrix, preferably a matrix comprising cellulose fibres, which is fixed by means of a conventional agent providing wet strength.

The adsorbent of the filter layer preferably has a porosity and/or charge distribution selected so that it can bind 2,4,6-trichloroanisole (TCA). In contrast, the adsorbent is essentially unable to bind other flavours, in particular of wine, e.g. isoamyl alcohol, 2-phenylethanol, ethyl lactate, tyrosol, tryptophol, hexanol, isoamyl acetate, ethyl hexanoate, ethyl octanoate, methionol, ethyl succinate, ethyl butanoate, benzyl alcohol, hexyl acetate, phenethyl acetate, 4-vinylguaiacol, ethylvaline, furfural, cis-/trans-3-hexenol, linalol, ethyl decanoate, acetovanillone, vanillin, heptanol, ethyl vanillate, guaiacol, b-damascenone, 5-methylfurfural, phenylacetaldehyde. The flavour profile of wine is thus essentially not adversely affected by the removal of the TCA, since only TCA is removed with high selectivity.

In very particularly preferred embodiments, a molecular sieve, in particular a zeolite, is located as adsorbent in the filter layer. The adsorption of polyhalogenated, in particular polychlorinated, aromatics such as anisole on zeolite is not known in the literature. The zeolite is particularly preferably an aluminium silicate having a void structure, in particular an aluminium silicate having essentially spherical voids having a diameter of less than 2 nm, in particular a diameter of about 1.2 nm, which voids are connected by channels of from about 740 pm to 800 pm.

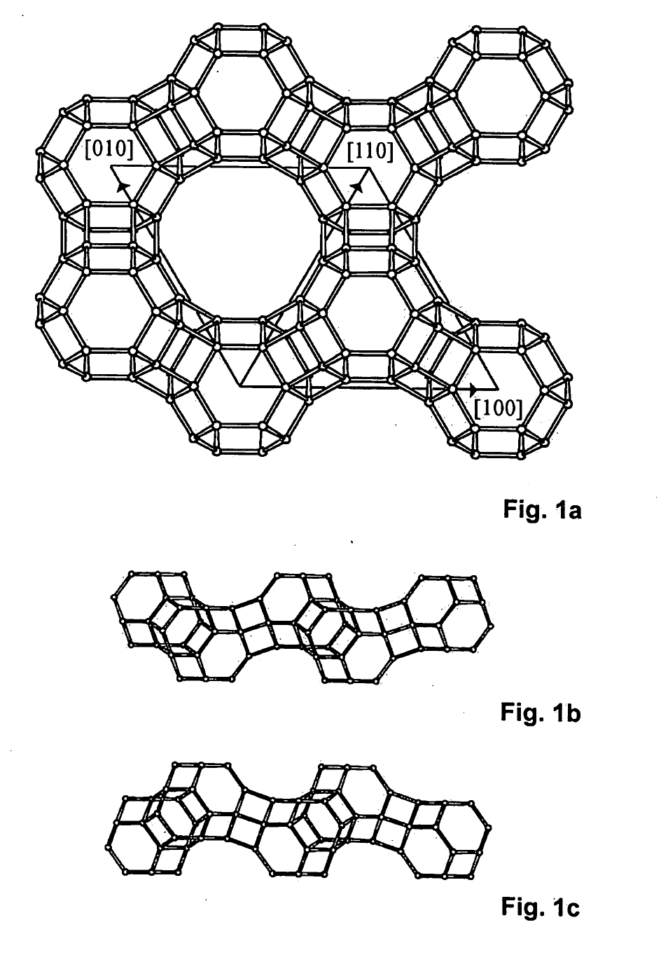

The adsorbent particularly advantageously has the periodic structural unit (PSU) of faujasites (cf. FIG. 1, bottom), in particular with a ratio of Si/Al of ≧5, preferably ≧10. Such zeolites are known per se to those skilled in the art and are commercially available, for example from

Grace Davison, 7500 Grace Drive, Columbia, Md. 21044, US: Grace Zeolite Products: Zeolite Y, ZSM-5, Beta;

Zeolyst International, P.O. Box 830, Valley Forge, Pa. 19482, US:

Zeolite Y (FAU): CBV400, CBV720, CBV760; CBV780, CBV901;

Natural Faujasite Company, Natural Faujasite Company L.L.C., P.O. Box: 708 al-jubeiha 11941, Amman-Jordan Jordan Faujasite.

It has been found that, the combination of the faujasite PSU and the high Si/Al ratio, in particular, can ensure particularly good adsorption of TCA. As regards the faujasite structural unit, reference may be made to the International Zeolite Association (www.iza-online.org), Database of Zeolite Structures, “The Faujasite Family”. In comparative experiments, it was shown that other zeolite structures such as BEA (having Si/Al ratios of 150 and 300) and MFI (nomenclature in accordance with International Zeolite Association) are able to bind TCA only weakly or not at all. An adsorbent which is suitable for use according to the present invention is described in detail in the European Patent Application EP 06005030 and the U.S. patent application Ser. No. 11/287,964 (G3 Enterprises, Modesto, Calif., USA); the disclosure of these documents in respect of the adsorbent is incorporated by reference into the present description.

In tectosilicates, the tetravalent silicon atoms can be partly replaced by trivalent aluminium atoms, for example in zeolites; here, the incorporation of each aluminium atom is associated with the occurrence of a negative charge. To balance the negative charges, cations such as H⁺, NH₄⁺, alkali metal cations, cations of the rare earth metals, are present. For the purposes of the invention, particular preference is given to H⁺ and/or Na⁺. The high Si/Al ratios according to the present invention thus mean tectosilicates having only little replacement of silicon atoms by aluminium atoms.

The amount of the adsorbent in the filter layer and the flow rate through the filter layer are the main factors by means of which the removal of, for example, TCA can be controlled; here, a reduction in the TCA content to <1 ng/l is desirable. The flow rate through the filter layer can be determined in a manner known per se by, for example, the pore size of the filter layer and/or the additional pressure/vacuum applied. In further preferred embodiments, the adsorbent is present in the (dry) filter layer in a proportion of from about 4.5% by weight to about 6.5% by weight. At such an amount of the adsorbent in the filter layer, a reduction to below 1 ng/l of TCA can be achieved at an industrially customary flow rate in the range from 300 to 400 l/m²/h through a filter layer and an original TCA content of 20 ng/l.

As an alternative to and/or in addition to the abovementioned types of zeolite, the adsorbent can also be activated carbon; a nonionic, in particular crosslinked resin such as a divinylbenzene resin; PVPP (polyvinylpolypyrrolidone); a synthetic aliphatic polymer such as PE (polyethylene), HDPE (high density PE), PP (polypropylene), HDPP (high density polypropylene), UHMWPE (polyethylene having a very high molecular weight), in each case modified by means of acid and/or hydroxyl groups if appropriate, as long as the abovementioned requirements in terms of the (selective) adsorption of, for example, TCA are met by appropriate choice of the additive.

A further aspect of the invention relates to a process for producing a filter layer, in which an adsorbent is added to remove a substance which adversely affects the taste from a fluid composition, in particular from wine, in a directed manner. The adsorbent is particularly advantageously premixed with water in a preliminary step and subsequently premixed with the further constituents of the filter layer. In this way, a homogeneous distribution of the adsorbent in the resulting filter layer can be ensured in a particularly simple way. As adsorbent, preference is given, as described above, to using an adsorbent having the periodic structural unit (PSU) of faujasites, in particular with a ratio of Si/Al of ≧5, preferably ≧10.

In a further aspect, the invention provides a process for removing a substance which adversely affects the taste from a fluid composition, in particular from wine. This process comprises the step of bringing into contact with, in particular passing through, a filter layer containing an adsorbent having the periodic structural unit (PSU) of faujasites, in particular with a ratio of Si/Al of ≧5, preferably ≧10.

The invention is illustrated below with the aid of figures which illustrate examples, without the subject matter of the invention being restricted to the examples indicated. In the figures

FIG. 1: Periodic structural unit of faujasite

perspective along [001];

perspective along [010];

perspective along [110].

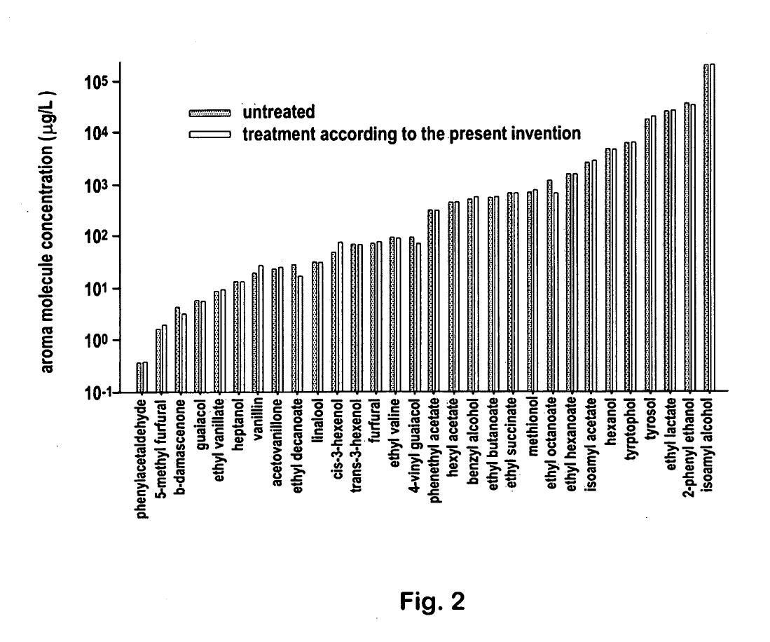

FIG. 2: Comparative experiments on the adsorption of flavours of wine.

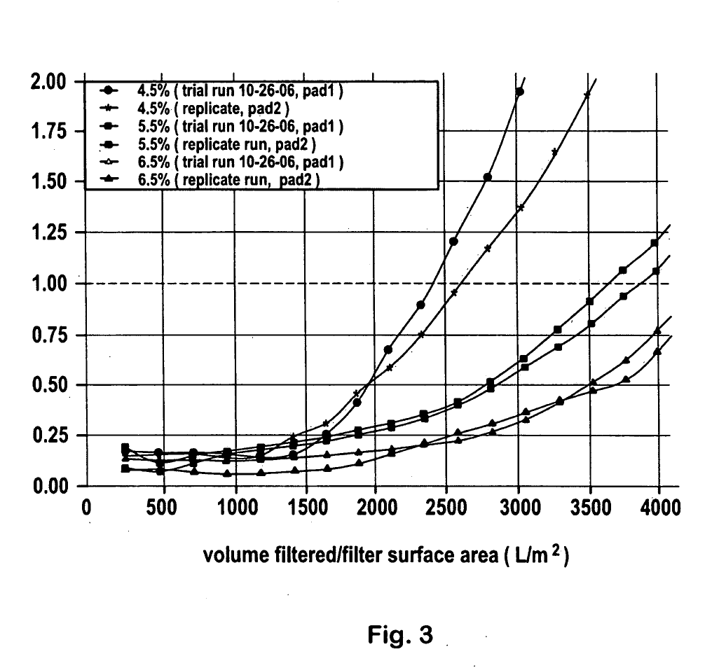

FIG. 3: Comparative experiments (filtered liquid volume per filter area, plotted against the remaining TCA concentration).

FIG. 1 shows the periodic structural unit (PSU) of the faujasite family, having SiO₄⁻ and AlO₄⁻ tetrahedra as smallest structural units (FIG. 1a: perspective along [001]; FIG. 1b: perspective along [010]; FIG. 1c: perspective along [110]). Partial replacement of Si by Al in framework silicates makes it possible to obtain zeolites having faujasite structural units and a ratio required according to the invention of Si/Al of ≧5, preferably ≧10.

A filter layer according to the invention was produced from the following constituents:

about 50% by weight of:
cellulose (degree of milling (SR) about 40-60
(hardwood (beech) and soft wood (spruce/pine)));
about 43.5-45.5% by weight of:
kieselguhr, uncalcined, having a permeability of
less than 30 mdarcy (here: Celite S from World
Minerals);
about 4.5-6.5% by weight of:
zeolite having faujasite PSUs and an Si/Al ratio
of 80 (Triex ®, G3 Enterprises).

A filter layer having a thickness of from about 3.7 to 3.9 mm was obtained, and by means of this it was possible to treat an amount of about 10 000 l of wine which was slightly contaminated with TCA (10 ng/l) at a filter area of about 10 m² and a flow rate of about 350 l/m²/h so that the resulting TCA content dropped significantly below 1 ng/l.

The production of the filter layers of the invention can be carried out using methods known per se to those skilled in the art. However, care has to be taken to ensure that the adsorbent is integrated very homogeneously into the filter layer. This can be achieved particularly simply and reliably by the adsorbent firstly being premixed with a comparatively small amount of a carrier medium, in particular water, and this premix only then being mixed with the further constituents of the filter layer. Thus, for example, the this premix of a suitable zeolite with water can be prepared in a drum by means of a hand mixer and subsequently emptied into a larger tank into which the filler (in the above example, the kieselguhr) can be introduced dry with stirring. The mixture obtained can subsequently, if appropriate after intermediate storage, be transferred into the mixing vat where it is mixed with the material forming the matrix, in particular the cellulose, and processed further in a manner known per se to form filter layers.

FIG. 2 shows a typical flavour profile of wine, both without and after treatment with the filter layer according to the above example. It can clearly be seen that the desired flavours are removed from the wine only to an insignificant extent by the adsorbent according to the invention, while TCA is reliably removed (see above).

FIG. 3 shows a study on the removal of TCA from red wine by means of the filter layers of the invention, in each case using different amounts of adsorbent and in each case in a duplicate measurement. The original TCA content is 20 ppt. The maximum tolerable amount of TCA after treatment was taken to be 1 ng/l (see abscissa). According to this study, the following filterable volumes are obtained for the filter layers:

4.5% by weight of absorbent (zeolite having
faujasite PSUs and an Si/Al ratio of 80 (Triex ®, G3
Enterprises))
about 2500 l/m²
5.5% by weight of absorbent (zeolite having
faujasite PSUs and an Si/Al ratio of 80 (Triex ®, G3
Enterprises))
about 3750 l/m²
6.5% by weight of absorbent (zeolite having
faujasite PSUs and an Si/Al ratio of 80 (Triex ®, G3
Enterprises))
about 4250 l/m²

These high possible throughput volumes underline the efficiency of the filter layers of the invention, which make inexpensive and selective removal of TCA possible. Particularly when using an adsorbent having a zeolite structure, regeneration of the filter layer by washing out bound TCA by means of a suitable solvent, preferably water, is also possible (backwashing).

1. Filter layer comprising an adsorbent for the directed removal of a substance from wine which adversely affects the taste.

2. Filter layer according to claim 1, further comprising a matrix.

3. Filter layer according to claim 2, wherein the matrix is a fibre matrix.

4. Filter layer according to claim 3, wherein the matrix comprises cellulose fibres.

5. Filter layer according to claim 1, wherein the adsorbent has a porosity and/or charge distribution such that it is able to bind 2,4,6-trichloroanisole but is essentially unable to bind other flavours of wine, with the flavours being selected from the group consisting of isoamyl alcohol, 2-phenylethanol, ethyl lactate, tyrosol, tryptophol, hexanol, isoamyl acetate, ethyl hexanoate, ethyl octanoate, methionol, ethyl succinate, ethyl butanoate, benzyl alcohol, hexyl acetate, phenethyl acetate, 4-vinylguaiacol, ethylvaline, furfural, cis-/trans-3-hexenol, linalol, ethyl decanoate, acetovanillone, vanillin, heptanol, ethyl vanillate, guaiacol, b-damascenone, 5-methylfurfural, phenyl-acetaldehyde.

6. Filter layer according to claim 1, wherein the adsorbent is present in such an amount and is chosen such that a reduction in the TCA content to below 1 ng/l is achievable at a flow rate of the fluid composition through the filter layer in the range from 300 to 400 l/m²/h, with an original content of 2,4,6-trichloroanisole (TCA) in the fluid composition of 20 ng/l.

7. Filter layer according to claim 1, wherein the adsorbent is a molecular sieve.

8. Filter layer according to claim 7, wherein the adsorbent is a zeolite.

9. Filter layer according to claim 8, wherein the zeolite is an aluminium silicate having a void structure.

10. Filter layer according to claim 9, wherein the aluminium silicate has essentially spherical voids with a diameter of ≦2 nm, which voids are connected by channels of from about 740 to 800 pm.

11. Filter layer according to claim 10, wherein the adsorbent has the periodic structural unit (PSU) of faujasites.

12. Filter layer according to claim 11, wherein the faujasite has a ratio of Si/Al of ≧5.

13. Filter layer according to claim 1, wherein the adsorbent is a Y-zeolite (faujasite) having a ratio of Si/Al of ≧5.

14. Filter layer according to claim 1, characterized in that the adsorbent is present in a proportion of from about 4.5% by dry weight to about 6.5% by dry weight.

15. Filter layer according to claim 1, characterized in that the adsorbent is selected from the group consisting of activated carbon; nonionic, in particular crosslinked resins, preferably divinylbenzene resins; PVPP (polyvinylpolypyrrolidone); synthetic aliphatic polymers, in particular PE (polyethylene), HDPE (high density PE), PP (polypropylene), HDPP (high density polypropylene), UHMW PE (polyethylene having a very high molecular weight), in each case unmodified or modified with acid and/or hydroxyl groups; and mixtures thereof.

16. Method of producing a filter layer according to claim 1, comprising the step of adding an adsorbent to remove a substance from wine in a directed manner, which adversely affects the taste.

17. Method according to claim 16, wherein the adsorbent is premixed with a carrier medium and is subsequently mixed with the further constituents of the filter layer.

18. Method according to claim 16, wherein the adsorbent has the periodic structural unit (PSU) of faujasites.

19. Method according to claim 18, wherein the faujasite has a ratio of Si/Al of ≧5.

20. Method of removing a substance from wine which adversely affects the taste, comprising the step of bringing the wine into contact with a filter layer containing an adsorbent having the periodic structural unit (PSU) of faujasites with a ratio of Si/Al of ≧5.
